(19) United States
(12) Patent Application Publication
(10) Pub. No.: US 2017/0133953 A1
(43) Pub. Date: May 11, 2017

(54) LOW FREQUENCY DUAL MODE ENERGY HARVESTING METHODS, SYSTEMS, AND PORTABLE DEVICES

(71) Applicant: TekCapital LLC, North Miami, FL (US)

(72) Inventors: Clifford M. Gross, Miami, FL (US); Michael Kayat, Apollo Beach, FL (US)

(21) Appl. No.: 14/933,507

(22) Filed: Nov. 5, 2015

(51) Int. Cl. H02N 2/18; H02J 7/00

(52) U.S. Cl. CPC H02N 2/181; H02N 2/186; H02J 7/0068

(57) ABSTRACT

Dual mode energy harvesting methods and portable devices that use a combination spring-type piezoelectric and electromagnetic transducer contained in a hollow casing or housing with first and second insulated, coil-shaped wire springs coated with a conductive surface electrode and piezoelectric material separated and connected at opposing ends by a movable proof mass comprising a high magnetic field strength rare earth magnet that to generate harvest energy from human motion, including walking jogging, running, and jumping, to charge external devices that include, for example, cellphones, smartphones, fitness bands, electronic readers, tablet computers, digital cameras, smart eyewear, and wearable cameras.

### FIELD OF THE INVENTION

The present invention relates to vibration-based energy harvesting methods, systems, and devices. More specifically, it relates to novel systems, methods, and portable devices that house an energy harvesting module that harvests energy from low frequency vibrations from a wide range of human motion. That energy can be stored and used to charge external devices that include, for example, cellphones, smartphones, fitness bands, electronic readers, tablet computers, digital cameras, together with newly emerging product categories, such as smart eyewear, and wearable cameras.

The inventive dual mode energy harvesting module can be incorporated directly into the external devices themselves or integrated into an energy harvesting device that is separate from the myriad external devices that the energy harvesting device can be used to charge. The separate energy harvesting device can utilize many different forms described herein that include that include a small, compact, cigarette package-shaped housing, an arm band, leg band, or hip pack.

### BACKGROUND

Cellular, rechargeable battery-powered, portable electronic devices are ubiquitous, including, for example, cellphones, smartphones, fitness bands, electronic readers, tablet computers, digital cameras, together with newly emerging product categories as smart eyewear, wearable cameras and others. Each new product generation provides additional features, applications and services which demand additional battery capacities. Battery lifetimes for such devices are measured in terms of several hours to a few days. Extending battery longevity is increasingly difficult and causes regular inconveniences to users as they strive to recharge their devices anywhere, anytime.

Extracting power from ambient sources is generally known as energy harvesting, or energy scavenging. Ambient sources of energy available for harvesting include light, radio frequency (RF) electromagnetic radiation, thermal gradients, and motion, including human motion from walking, jogging, running, jumping, and the like, and fluid flow. Michelson et al, “Energy Harvesting From Human and Machine Motion,” Proc. IEEE, 96, (2008). Energy harvesting from human motion in particular has been described as a promising area for investigation. Gorlatova, et al., “Movers and Shakers: Kinetic Energy Harvesting for the Internet of Things,” Columbia University, Electrical Engineering Technical Report #2014-03-27, (2014).

In general, power harvesting devices are mechanical-to-electrical energy converters. Such devices can consist of a mass-spring system coupled to a frame or cantilever beam which is displaced by outside vibrations, shocks, or other motion. The mass-spring or cantilever beam system acts as a damper for the motion of the frame, thereby acquiring kinetic energy. Transduction of mechanical-to-electrical energy can be piezoelectric (strain in a bending or stress in a compressing element that produces output voltage). It can also be electromagnetic (e.g., magnet moving relative to a coil), or electrostatic (e.g., charged objects moving past each other).

Vibration-based kinetic harvesting has been used to generate power to at least partially charge portable electronic products. However, generally, energy harvesting has suffered from low, variable, and unpredictable levels of available power. Harvesting energy from human motion for powering wearable or portable electronics presents particular challenges. By way of example, frequencies of ordinary human motion (e.g., walking) are typically very low (e.g., 1-2 Hz), the amplitudes of the movements are high (e.g., 10 cm), and the weight and size of the devices are to harvest energy, if they are to be practical, are limited to unobtrusive amounts and dimensions.

As a consequence, the amount of power available from typical power generating systems has been too limited to be practical. Moreover, portable electronics are becoming increasingly sophisticated and consuming more and more power, even though efforts have been made to improve battery longevity. Another limitation of many energy harvesting systems is that they harvest power only in one dimension. By way of example, a moving piston within a generator positioned in the heel of the shoe can be used to generate power. Any energy available from motion other directions, such as pivoting motions, is lost.

Motion-driven energy harvesting methods fall into two categories: those that utilize direct application of force and those that make use of inertial forces acting on a proof mass. In order to generate power from these methods, a suitable transducer must be used to convert energy to a form that can be used to charge devices.

Electromagnetic methods to convert vibrations to electrical power have included using a unitary directionally magnetized permanent magnet ball that rolls and translates inside a spherical housing when subjected to human motion. The sphere containing the magnetic ball is wrapped with one or more copper coils. When the ball moves, the coils “sense” the time-varying magnetic flux and thus generate a voltage. Bowers, B., et al., “Spherical, Rolling Magnet Generators for Passive Energy Harvesting from Human Motion,” 19 (2009), Journal of Micromechanics and Microengineering, Article No. 094008. Another similar, but different approach is described in U.S. Pat. No. 8,723,342.

U.S. Pat. No. 8,729,747 (Arnold et al.) describes using a spherical, cylindrical, or elliptical magnet. The magnet can roll about a linear, cylindrical, helical, or cage-like track. The changing magnetic flux due to the magnet rolling about the track induces current in surrounding coils. The coils can be provided around the track using a continuous winding placement, segmented winding placement, or fractional winding placement. Multiple coil phases are also possible. For embodiments utilizing multiple magnets, spacers can be used to maintain a separation between magnets.

Piezoelectric energy harvesting systems (PEHSs) directly convert applied mechanical energy into electricity, leading to a simpler device design as compared to other mechanisms, which require more complex geometries and additional components. However, PEHSs face challenges of low output power and high resonance frequency. Resonant frequency is usually higher than vibration frequency. When PEHSs are scaled down to micron size, they suffer low output power because energy harvesters generate maximum power at the resonant frequency.

The most commonly adopted ways to reduce resonant frequency in a power harvester are: 1) adding a mass to the energy harvester mechanism or 2) using a spring structure or the equivalent that can decrease the overall system stiffness and can significantly decrease the resonance frequency toward 1 kHz or less as compared with a beam-type structure with the same weight.

The electromagnetic, electrostatic, and piezoelectric methods for energy harvesting described above all have their advantages and disadvantages. There have been efforts to design energy harvesters that simultaneously rely upon more than one method of induction or conversion in an effort to maximize energy harvesting obtain the advantages and of more than one method and minimize the disadvantages of individual methods in attempting to develop an optimal design.

For example, U.S. Pat. No. 8,354,778 (Arnold, et al.) describes a dual-mode method and system that uses both piezoelectric and electromagnetic transduction in a vibrational energy harvester. Arnold, et al. describes using a cantilever beam with a piezoelectric patch, to which a permanent magnet is attached. However, the amount of current that can be generated is limited by the practical upward limit of the mass of the magnet in a bending beam configuration for a portable device operating at low frequency (1-5 Hz). This system would be better suited for higher frequency vibrations. Further, the bending beam geometry for the piezoelectric patch further limits the current generated as the beam bending is small and the surface area of the bending bars is also constrained. The current generated from the magnet also is limited because of the limited motion of the magnet.

Another dual mode system is described in US Patent Pub. No. 20150229242 (Chimkpam). Chimkpam's device comprises a housing, a mechanical spring engaged with the housing between a static and dynamic state and a first magnet engaged with the mechanical spring. The device further comprises a conductive grid freely moveable within a cavity of the housing. The device further comprises a composite structure comprising a fixed magnet and a piezoelectric material. The composite structure is engaged with the grid and in communication with the first magnet. The first magnet and the fixed magnet apply a force upon the piezoelectric material when the mechanical spring is in the static state to produce a base voltage.

The Chimamkpam invention comprises multiple fixed mechanical non-coil springs with attached magnets which, when the springs undergo induced vibrations from external sources, are repelled by fixed multiple magnets attached to fixed multiple piezoelectric blocks. This invention is designed to produce a range of different voltages from the moving magnets and piezoelectric blocks, over a wide frequency bandwith range and from multiple sources of vibrations, including acoustics, stray electromagnetic fields, ambient noise and various anatomical motions. The system is more of a multi-modal hybrid energy harvester device, better suited as a passive, fixed non-portable device that generates sub-optimal voltage outputs from multiple available sources of external vibrations and not applicable to the specific requirements for low frequency human motion induced vibrations.

To date, most kinetic energy harvesters continue to provide limited power densities that are ineffective. They can be difficult to use and take too long to generate significant energy. There continues to be a real and unmet need for a compact, stylish, unobtrusive energy harvester that can be easily deployed as a wearable accessory and which provides significant power densities for the increasing number of smart portable devices and more effectively utilizes low frequency vibrations for energy generation from human motion such as walking, jogging running, dancing, jumping and other physical activities.

As described in detail herein below, the methods, systems, and devices described herein employ a novel design for a dual mode energy harvesting module that uses a combination of piezoelectric and electromagnetic induction transducers, driven by the vibrations from human motion. The device can be contained within a very small size and volume. As explained below, this approach overcomes the disadvantages of using a one transduction type configuration and enhances the benefits of both piezoelectric and electromagnetic induction to generate higher power densities from low frequency vibrations.

The design specifically includes a combination spring type piezoelectric and electromagnetic transducer. The combination transducer is contained within a tube or casing and configured with two vertically positioned springs, separated and connected by a spherical movable proof mass. The movable proof mass could be cylindrical or spherical, but spherical shapes are preferred because they have the smallest surface area per unit volume than any other shape with highest magnetic field density. Each spring has different stiffness to ensure the proof mass, which as a downward force due to gravity, is positioned at the center height of the tube at equilibrium.

The springs are coated with a bi-layer of ferro-electric polymer and surface electrode materials to generate energy from both compression and surface shear stress. The electromagnetic transducer consists of a movable spherical proof mass which is a high strength rare earth permanent magnet, together with a set of insulated wire coils which are horizontally wrapped around the central region of the tube, exterior to the tube and extending a length to an upper and lower height along the tube. The spherical magnet is suspended at equilibrium, between the two springs, in the middle of the tube and in the middle of the set of coils. If an external vibration is applied to the tube, the magnet will begin to oscillate vertically, compressing and expanding the springs in turn, passing through the total length of the wire coils, and generating voltage from each transducer. Thus energy can be harvested simultaneously from both methods of induction.

### SUMMARY OF THE INVENTION

As described in detail herein below, the methods, systems, and devices described herein employ a novel design for a dual mode energy harvesting module that uses a combination of piezoelectric and electromagnetic induction transducers, driven by the vibrations from human motion. The device can be contained within a very small size and volume. As explained below, this approach overcomes the disadvantages of using a one transduction type configuration and enhances the benefits of both piezoelectric and electromagnetic induction to generate higher power densities from low frequency vibrations.

The design specifically includes a combination spring type piezoelectric and electromagnetic transducer. The combination transducer is contained within a tube or casing and configured with two vertically positioned springs, separated and connected by a spherical movable proof mass. The movable proof mass could be cylindrical or spherical, but spherical shapes are preferred because they have the smallest surface area per unit volume than any other shape with highest magnetic field density. Each spring has different stiffness to ensure the proof mass, which as a downward force due to gravity, is positioned at the center height of the tube at equilibrium.

The springs are coated with a bi-layer of ferro-electric polymer and surface electrode materials to generate energy from both compression and surface shear stress. The electromagnetic transducer consists of a movable spherical proof mass which is a high strength rare earth permanent magnet, together with a set of insulated wire coils which are horizontally wrapped around the central region of the tube, exterior to the tube and extending a length to an upper and lower height along the tube. The spherical magnet is suspended at equilibrium, between the two springs, in the middle of the tube and in the middle of the set of coils. If an external vibration is applied to the tube, the magnet will begin to oscillate vertically, compressing and expanding the springs in turn, passing through the total length of the wire coils, and generating voltage from each transducer. Thus energy can be harvested simultaneously from both methods of induction.

In accordance with a first aspect of the invention, there is provided an energy harvesting module for generating power from low frequency vibrations of human motion comprising a combination spring-type piezoelectric and electromagnetic transducer contained in a hollow casing or tubing, the combination transducer comprising: electromagnetic induction and piezoelectric transducers; first and second insulated, coil-shaped wire springs coated with a conductive surface electrode and piezoelectric material, the first and second springs separated and connected at opposing ends by a movable proof mass comprising a high magnetic field strength rare earth magnet, the first and the second springs having different stiffness so that the spherical mass is positioned at the center height of the casing or tubing at equilibrium, the first and second springs horizontally wrapped around a central region of the tube or casing, exterior to the tube or casing and extending vertically through the tube or casing, the proof mass oscillating vertically and compressing the first and the second vertically to generate mechanical energy and electromagnetic energy when external vibration is applied to the casing or tubing from human motion.

In another embodiment, wherein the piezoelectric material is a ferro-electric polymer, poly (vinylidene fluoride-trifluoroethylene), or P(VDF-TrFE). In another aspect, the spherical proof mass is a rare earth permanent magnet of an alloy of neodymium, iron and boron (NdEeB).

In another embodiment, the tube or casing is between 1 to 2 cm. in diameter and between 5 to 10 cm. in length. In another embodiment, the mass of the springs is less than the mass of the movable spherical proof mass. In another embodiment, the human motion includes walking, jogging, running, cycling, jumping, dancing, and horse riding, and other physical activities.

In accordance with a second aspect, an energy harvesting device is provided comprising an energy harvesting module for generating power from low frequency vibrations of human motion; an internal battery; a low loss rectifier free circuit power conditioning module connected to the energy harvesting module and the internal battery that converts AC power generated from the energy harvesting module to DC voltage for storage in the internal battery, wherein the energy harvesting module comprises a combination spring-type and electromagnetic transducer contained in a hollow casing or tubing, the combination transducer comprising electromagnetic and piezoelectric transducers connected to the internal battery and the low loss rectifier free circuit power conditioning module and the first and second insulated, coil-shaped wire springs coated with a conductive surface electrode and piezoelectric material, the first and second wire springs, the first and second springs separated and connected by a movable spherical proof mass comprising a high strength rare earth magnet, the first and the second springs having different stiffness so that the spherical mass is positioned at the center height of the casing or tubing at equilibrium, the first and second springs horizontally wrapped around the central region of the tube or casing, exterior to the tube or casing and extending vertically through the tube or casing, the movable spherical proof mass oscillating vertically and the first and the second springs compressing vertically to generate mechanical energy and electromagnetic energy when external vibration is applied to the casing or tubing from human motion.

In another embodiment, the piezoelectric material is a ferro-electric polymer, poly (vinylidene fluoride-trifluoroethylene), or P(VDF-TrFE). In another embodiment, the surface electrode is platinum. In another embodiment, wherein the spherical proof mass is a rare earth permanent magnet of an alloy of neodymium, iron and boron (NdEeB).

In another embodiment, the tube or casing is between 1 to 2 cm. in diameter and between 5 to 10 cm. in length.

In another embodiment, the mass of the first and the second springs is less than the mass of the proof mass. In another embodiment, the energy harvesting device is in the form of or incorporated into an armband, wristband, or, ankle band, or cigarette box shaped housing and the human motion includes walking, jogging, running, cycling, jumping, dancing, or horse riding. In another embodiment, the energy harvesting further comprises an LED display; an electronic module that measures charge level on the internal battery and displays the charge level on the LED display.

In another embodiment, the energy harvesting device further comprises circuitry that detects and can transfer charge from the internal battery to external USB devices that include cellphones, smartphones, fitness bands, electronic readers, tablet computers, and digital cameras, smart eyewear, and wearable cameras. In another embodiment, displacement of the proof mass is 2-6 cm.

In a third aspect, a method is provided for harvesting energy from human motion to charge external USB devices, including cellphones, smartphones, smartwatches, fitness bands, electronic readers, tablet computers, digital cameras, smart eyewear, and wearable cameras, comprising connecting the energy harvesting device to an external USB device; running, cycling, jumping, dancing, horse riding or engaging in other physical activities while wearing or carrying the energy harvesting device; causing a movable spherical proof mass inside the energy harvesting device to oscillate vertically and first and the second springs inside the energy harvesting device to compress vertically to generate mechanical energy and electromagnetic energy that is converted in a low loss rectifier free circuit power conditioning module connected to the energy harvesting module and an internal battery in the energy harvesting device that converts AC power generated from the energy harvesting module to DC voltage for storage in the internal battery; and transferring power from the internal battery to the connected USB external device.

In another embodiment, the external USB device is a cellphone, smartphone, fitness band, electronic reader, tablet computer, digital camera, smart eyewear, and wearable camera.

In another embodiment, the method further comprises waiting until an LED display on the energy harvesting device indicates that there is sufficient energy stored in the internal battery to charge the external USB device.

### BRIEF DESCRIPTION OF THE DRAWINGS

FIGS. 1A, 1B, and 1C depict examples of various forms in which the inventive hybrid energy harvesting device can be incorporated.

FIG. 2 is a diagram illustrating the high level architecture of the inventive dual mode energy harvesting device according to one embodiment.

FIGS. 3A-3C contain tables that summarize battery charge levels and capacities for exemplary portable USB-based smart phones and other portable USB-based consumer electronics.

FIG. 4 is a schematic diagram of the dual mode energy harvesting module that demonstrates the operation of the dual mode energy harvesting module.

FIG. 5 is a schematic diagram of the dual mode energy harvesting module that further demonstrates the operation of the dual mode energy harvesting module.

FIG. 6 represents a cross section view of a spring-type dual mode transducer used in the inventive energy harvesting module.

FIG. 7 is a schematic diagram of an embodiment of the novel energy harvesting device with movable spherical movable proof mass magnet oscillating across the width of a wound coil.

### DETAILED DESCRIPTION

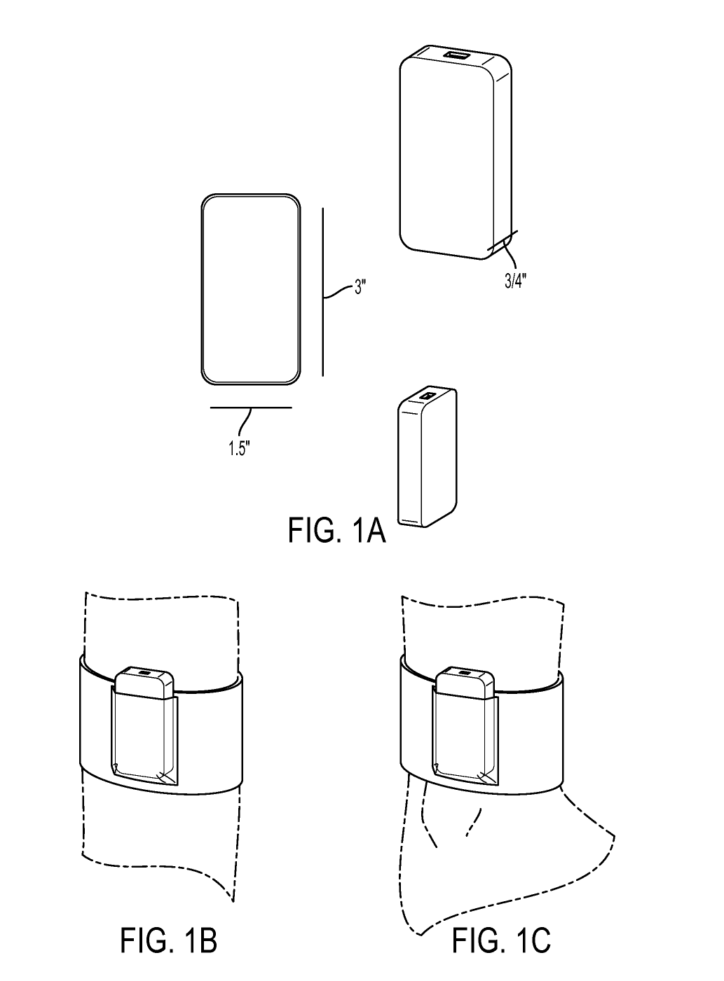

FIGS. 1A, 1B, and 1C depict example embodiments of the forms into which the combination energy harvester device described below can be incorporated to harvest, convert, and store energy from low frequency vibrations from a wide range of human motion into electrical energy that charges a battery or supercapacitor in the energy harvesting device that can in turn be used to charge external devices, including, for example, cellphones, smartphones, fitness bands, electronic readers, tablet computers, digital cameras, together with newly emerging product categories as smart eyewear, wearable cameras and others. Alternatively, the novel energy harvesting device can be incorporated and integrated directly into the device itself.

FIG. 1A depicts a cigarette pack size case into which the novel energy harvesting device can be incorporated and integrated. The energy harvesting device also can be incorporated and integrated into an arm band (FIG. 1B) or ankle band (FIG. 1C) that can be worn by a user. Alternatively, the device could be stored in a pocket, purse or briefcase that is carried while moving.

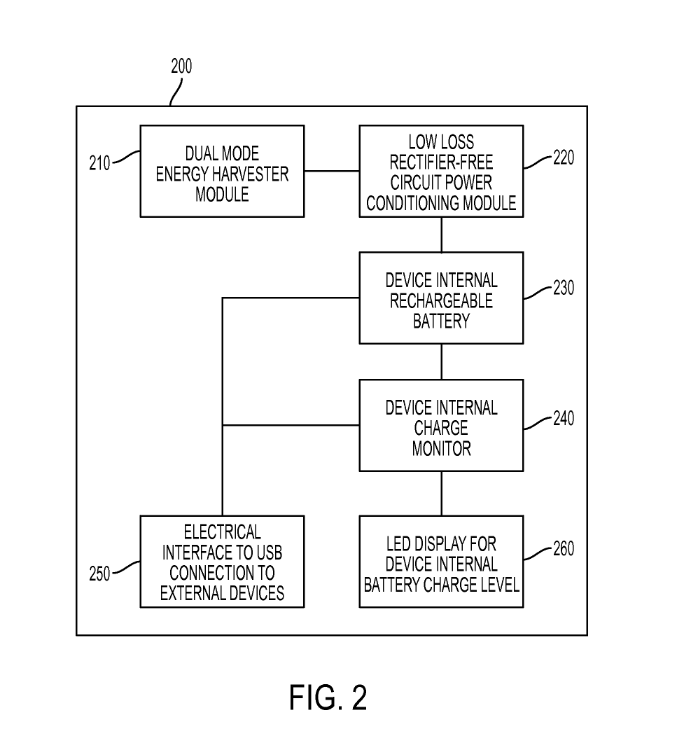

FIG. 2 depicts the high level architecture of the novel energy harvesting device 200 according to one embodiment, with dual mode energy harvester module 210 described in further detail herein, which is connected to a low loss, rectifier free circuit power conditioning module 220 that converts the alternating current (AC) voltage generated by the energy harvester module to direct current (DC) voltage that can be stored in the device internal rechargeable battery 230, which is connected to the device internal battery charge monitor 240, and which contains a circuit that continually measures the electrical charge he charge level of the device internal rechargeable battery 230. The rectifier free circuit power conditioning module 220 provides low-loss, high efficiency, low voltage sensitivity AC to DC voltage conditioning from the different transducers, without using traditional diodes. Alternatively, a traditional rectification circuit could be utilized as part of the power conditioning module could be used instead of rectifier free circuit power conditioning module 220. The charge level of device internal battery 230 can be displayed on the connected LED display 260. An electrical interface for USB connection to external devices 250 can be connected to a variety of external USB devices and is also connected to device internal rechargeable battery 230 to transfer stored electrical power from the device internal rechargeable battery 230 to an external portable USB device. The LED display 260 provides the user with a status: fully charged, half capacity or low for example less than 10%.

Devices that are suitable to be recharged with the device include cellphones, smartphones, fitness bands, electronic readers, tablet computers, digital cameras, smart watches, eyewear, wearable cameras, and other USB chargeable devices. Alternatively, electrical interface for USB connection to external devices 250 could be replaced with other methods of power transfer.

The device internal rechargeable battery 230 can be of many different types, including lithium ion, lithium ion polymer, nickel cadmium, nickel metal hydride and others. Alternatively, a supercapacitor may be used as the charge storage element that includes EDLC, pseudo-capacitors. New generations of batteries based on graphene also could be suitable.

The dual mode energy harvester module 210 and can be tuned for optimal power density for low frequency vibrations, typically very challenging for single mode energy harvesters because of such low frequency vibrations that are generated by human motion. The hybrid energy harvester can also be adapted for generating optimal power densities at higher frequency ranges by adjusting the key characteristics of each transducer component of the energy harvester.

Different types of consumer electronics devices have very different energy requirements which affect battery life. Many devices are becoming applications-rich with every new generation, and which need increased processor speeds, memory and communications.

Effective use of energy harvesting depends on understanding energy usage profiles, and matching them with the optimal energy available from harvesting by restricting the response bandwidth to a narrow 1-5 Hz frequency range, in the case of human motion.

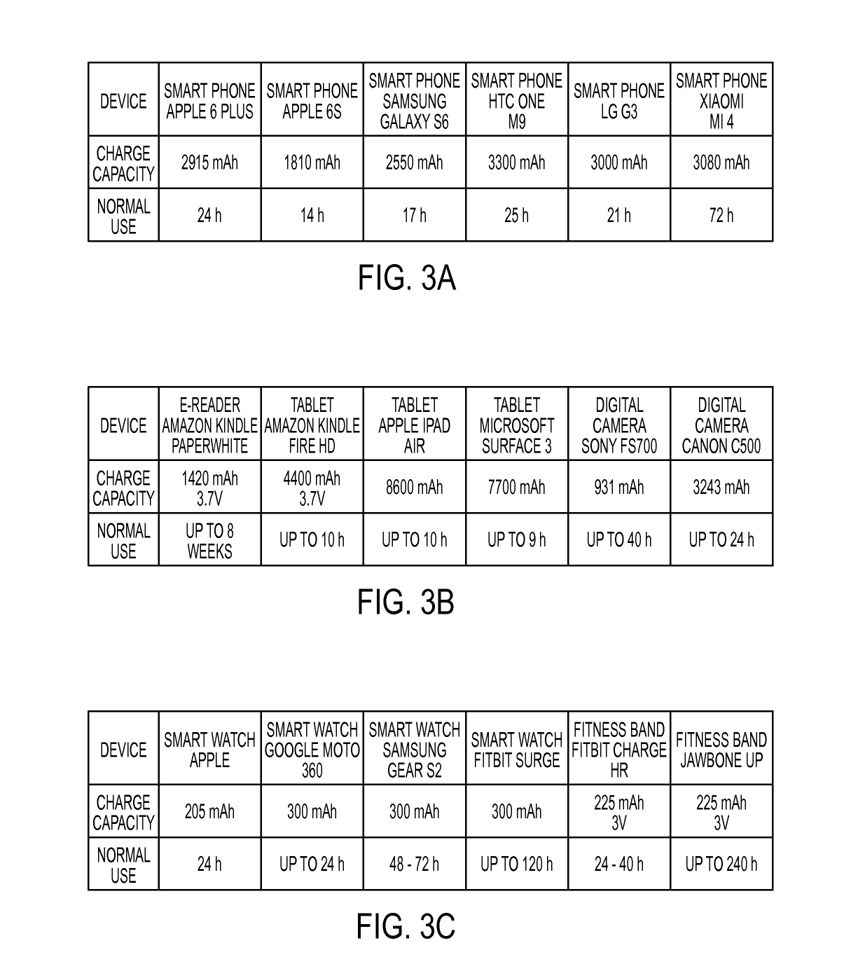

FIGS. 3 A-C contain tables that summarize battery charge levels and capacities for exemplary portable USB-based smart phones and other portable USB-based consumer electronics. The example hybrid energy harvesting device uses a novel and unique combination of piezoelectric and electromagnetic induction transducers which effectively cooperate to generate significant power densities in the low frequency ranges between 1 to 10 Hz.

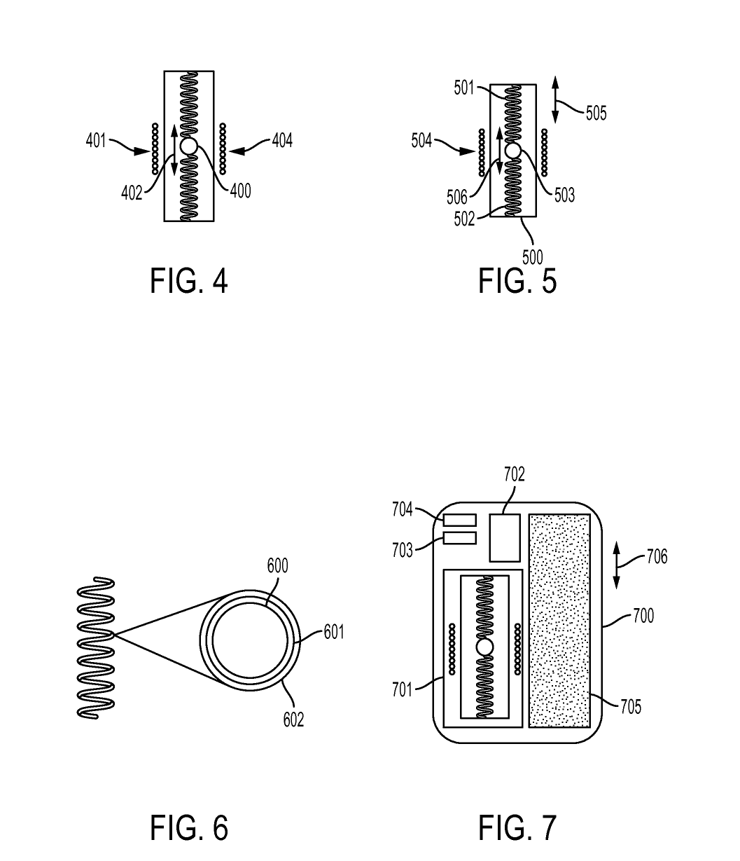

A schematic design of the dual energy harvester module is shown in FIG. 4. The vertical cylindrical tube 400 contains both the piezoelectric and electromagnetic transducers. Coil-shaped springs 401 and 402 are each connected to a movable proof mass 403, to form a vertical non-linear two spring/one mass system with damping forces. The AC voltage outputs from each type of transducer are rectified to DC than added together to provide a total DC voltage output.

The mass of each spring is similar and less than the movable proof mass. The stiffness (spring constant) for each spring 401 and 402 is different, to accommodate the gravitational force on the movable proof mass maintains an equilibrium position such that the lengths of the springs are equal. The lengths of each spring, spring constants and proof mass, together with the displacement range of the movable proof mass, the damping forces caused by air resistance and electromagnetic induction caused by the oscillating proof magnet and external vibrations, determine the dynamics of the spring type piezoelectric system. The ratio of the effective system spring constant and the movable proof mass are key parameters for maximizing power output and to closely match overall dominant system frequency with energy harvester resonance frequency to provide a maximum total voltage output between 1 to 5 Hz.

The insulated copper wire coils, 404, are shown on the exterior of the tube, wrapped horizontally to cover a vertical width (height) around the center of the tube. The coil configurations (width, wire diameter, resistance, total wire length), type, size and weight, magnetic field strength and coercivity of the magnet, displacement distance of the proof mass magnet through the coil, space between moving magnet and coil determine the dynamics of the electromagnetic induction system, together with the associated Lorentz force electromagnetic induction damping.

When a conductor moves through a non-uniform, external magnetic field, the magnetic flux varies through loops fixed inside the conductor, so an electromotive force is induced around the loops, according to Faraday's law and eddy currents flow. The Lorentz force on these eddy currents, due to the external magnetic field, opposes the motion, which is electromagnetic damping.

FIG. 5 is a schematic diagram of the dual mode energy harvesting module that further demonstrates the operation of the dual mode energy harvesting module. The vertical cylindrical tube or casing 500 contains both the piezoelectric and electromagnetic transducers in a compact space. The two springs 501 and 502 inside the tube or casing 500 are each connected to a movable proof mass 503 to form a vertical, non-linear, two spring one mass system with damping forces. The direction of vertical motion of the energy harvesting module is also indicated, driven by external vibrations 505. The direction of vertical motion of the dual springs and movable proof mass within the tube is shown, 506. The springs are piezoelectric (of either differing [to account for gravitational orientation] or similar stiffness) which results in a large deformable surface area and a proportionally larger current, all more responsive to low frequencies and mass displacements on the order of 2-6 cm which corresponds to the vertical displacement of the center of mass of the body at the second sacral vertebra while walking, hence improved biomechanical compliance for efficiently capturing low frequency vibrations resulting from human motion.

Additional detail about the construction of the piezoelectric springs is shown in FIG. 6. Additional detail about the construction of the piezoelectric springs is also shown in FIG. 6. The cross section of a spring-type piezoelectric transducer as inner iron core, 600, middle layer of ferro-electric polymer, poly (vinylidene fluoride-trifluoroethylene) or P(VDF-TrFE), 601, and the outer layer surface electrode comprising platinum deposition, 602. Induced piezoelectric current and voltage is generated from an amplified conversion of applied, cycling vertical stress into shear stress. The spring-type piezoelectric transducer more efficiently converts the mechanical energy into electrical voltage with a relatively large piezoelectric coefficient.

FIG. 7 shows the cross section of the electromagnetic transducer with spherical movable proof mass magnet, 700, oscillating across the width of the wound coil, 701. Induced electric current and voltage is generated (Faraday's Law of Induction) in the coil circuit from the moving magnetic flux, as indicated by the vertical motion 702. The wire coil can include a range of wire thickness, diameter and wire spacing, number of wires and total resistance. The spherical magnet can include a range of different types, for example, rare earth NdFeB, with different sizes, different magnetic field strengths and coercivities.

The schematic of the energy harvester device is shown in FIG. 7. The device, 700, contains the integrated piezoelectric and electromagnetic induction transducers, 701, which are connected to the power conditioning module, 702, internal battery charge module, 703, electrical interface module, 704, and the internal rechargeable battery, 705. The vertical motion of the device is also indicated, 706. The device 700 is small enough to fit comfortably inside a user's pockets and bags, for example, shirt, waist and pants pockets. The device 700 can also be placed in a wearable sports band around a user's arm, leg or ankle.

A method for harvesting energy from human motion to charge external USB devices, including cellphones, smartphones, smartwatches, fitness bands, electronic readers, tablet computers, digital cameras, smart eyewear, and wearable cameras, comprises wearing or carrying an energy harvesting device described herein; walking, running, cycling, jumping, dancing, horse riding, or engaging in other activities where the user is moving while wearing or carrying the energy harvesting device; connecting the energy harvesting device to an external USB device; and transferring charge from the internal battery to a rechargeable battery in the external USB device that includes a cellphone, smartphone, fitness band, electronic reader, tablet computer, digital camera, smart eyewear, wearable camera, or any other USB-based device. The user can either wait until the LED display indicates that there is sufficient energy stored in the internal battery to fully charge the external USB device or can keep the device connected while engaging in activity to continually replenish battery strength while using the device.

The overall size, shape and weight of the hybrid energy harvester configuration may be adapted to a wide range of applications, technology and materials. For example, micro-embedded versions may be integrated with a wide range of future portable electronic devices or even implanted directly inside the human body.

One skilled in the art will realize the invention may be embodied in other specific forms without departing from the spirit or essential characteristics thereof. The foregoing embodiments are therefore to be considered in all respects illustrative rather than limiting of the invention described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on this application based hereon. Accordingly, the disclosure of the embodiments of the invention is intended to be illustrative, but not limiting, of the scope of the invention.

The invention has been described in terms of particular embodiments. The alternatives described herein are examples for illustration only and not to limit the alternatives in any way. The steps of the invention can be performed in a different order and still achieve desirable results. It will be obvious to persons skilled in the art to make various changes and modifications to the invention described herein. To the extent that these variations depart from the scope and spirit of what is described herein, they are intended to be encompassed therein. It will be understood by those skilled in the art that various changes in form and details may be made therein without departing from the scope of the invention encompassed by the appended claims.

What is claimed is:

1. An energy harvesting module for generating power from low frequency vibrations of human motion comprising:
a combination spring-type piezoelectric and electromagnetic transducer contained in a hollow casing or tubing,
the combination transducer comprising:
electromagnetic induction and piezoelectric transducers;
first and second insulated, coil-shaped wire springs coated with a conductive surface electrode and piezoelectric material,
the first and second springs separated and connected at opposing ends by a movable proof mass comprising a high magnetic field strength rare earth magnet,
the first and the second springs having different stiffness so that the proof mass is positioned at the center height of the casing or tubing at equilibrium, the first and second springs horizontally wrapped around a central region of the tube or casing, exterior to the tube or casing and extending vertically through the tube or casing,
the proof mass oscillating vertically and compressing the first and the second vertically to generate mechanical energy and electromagnetic energy when external vibration is applied to the casing or tubing from human motion.

2. The energy harvesting module of claim 1, wherein the piezoelectric material is a ferro-electric polymer, poly (vinylidene fluoride-trifluoroethylene), or P(VDF-TrFE).

3. The energy harvesting module of claim 1, wherein the surface electrode is platinum.

4. The energy harvesting module of claim 1, wherein the spherical proof mass is a rare earth permanent magnet of an alloy of neodymium, iron and boron (NdEeB).

5. The energy harvesting module of claim 1, wherein the tube or casing is between 1 to 2 cm. in diameter and between 5 to 10 cm. in length.

6. The energy harvesting module of claim 1, wherein the mass of the springs is less than the mass of the movable spherical proof mass.

7. The energy harvesting module of claim 1 of claim, wherein the human motion includes walking, jogging, running, cycling, jumping, dancing, and horse riding.

8. An energy harvesting device comprising:
an energy harvesting module for generating power from low frequency vibrations of human motion;
an internal battery;
a low loss rectifier free circuit power conditioning module connected to the energy harvesting module and the internal battery that converts AC power generated from the energy harvesting module to DC voltage for storage in the internal battery, wherein the energy harvesting module comprises a combination spring-type and electromagnetic transducer contained in a hollow casing or tubing,
the combination transducer comprising electromagnetic and piezoelectric transducers connected to the internal battery and the low loss rectifier free circuit power conditioning module and the first and second insulated, coil-shaped wire springs coated with a conductive surface electrode and piezoelectric material,
the first and second wire springs, the first and second springs separated and connected by a movable spherical proof mass comprising a high strength rare earth magnet,
the first and the second springs having different stiffness so that the spherical mass is positioned at the center height of the casing or tubing at equilibrium, the first and second springs horizontally wrapped around the central region of the tube or casing, exterior to the tube or casing and extending vertically through the tube or casing,
the movable spherical proof mass oscillating vertically and the first and the second springs compressing vertically to generate mechanical energy and electromagnetic energy when external vibration is applied to the casing or tubing from human motion.

9. The energy harvesting device of claim 8, wherein the piezoelectric material is a ferro-electric polymer, poly (vinylidene fluoride-trifluoroethylene), or P(VDF-TrFE).

10. The energy harvesting device of claim 8, wherein the surface electrode is platinum and a traditional rectification circuit is used instead of the rectifier free circuit power conditioning module.

11. The energy harvesting device of claim 8, wherein the spherical proof mass is a rare earth permanent magnet of an alloy of neodymium, iron and boron (NdEeB).

12. The energy harvesting device of claim 8, wherein the tube or casing is between 1 to 2 cm. in diameter and between 5 to 10 cm. in length.

13. The energy harvesting device of claim 8, wherein the mass of the first and the second springs is less than the mass of the proof mass.

14. The energy harvesting device of claim 8 of claim, wherein the energy harvesting device is in the form of or incorporated into an armband, wristband, or, ankle band, or cigarette box shaped housing and the human motion includes walking, jogging, running, cycling, jumping, dancing, or horse riding.

15. The energy harvesting device of claim 14, further comprising:
an LED display;
an electronic module that measures charge level on the internal battery and displays the charge level on the LED display.

16. The energy harvesting device of claim 15, further comprising circuitry that detects and can transfer charge from the internal battery to external USB devices that include cellphones, smartphones, fitness bands, electronic readers, tablet computers, and digital cameras, smart eyewear, and wearable cameras.

17. The energy harvesting device of claim 16, wherein displacement of the proof mass is 2-6 cm.

18. A method for harvesting energy from human motion to charge external USB devices, including cellphones, smartphones, smartwatches, fitness bands, electronic readers, tablet computers, digital cameras, smart eyewear, and wearable cameras, comprising:
connecting the energy harvesting device to an external USB device;
running, cycling, jumping, dancing, horse riding or engaging in other physical activities while wearing or carrying the energy harvesting device;
causing a movable spherical proof mass inside the energy harvesting device to oscillate vertically and first and the second springs inside the energy harvesting device to compress vertically to generate mechanical energy and electromagnetic energy that is converted in a low loss rectifier free circuit power conditioning module connected to the energy harvesting module and an internal battery in the energy harvesting device that converts AC power generated from the energy harvesting module to DC voltage for storage in the internal battery; and
transferring power from the internal battery to the connected USB external device.

19. The method of claim 17, where the external USB device is a cellphone, smartphone, fitness band, electronic reader, tablet computer, digital camera, smart eyewear, and wearable camera.

20. The method of claim 18, further comprising:
waiting until an LED display on the energy harvesting device indicates that there is sufficient energy stored in the internal battery to charge the external USB device.
